(19) United States
(12) Patent Application Publication
(10) Pub. No.: US 2011/0269012 A1
(43) Pub. Date: Nov. 3, 2011

(54) GALVANIC ELEMENT WITH COMPOSITE OF ELECTRODES, AND SEPARATOR FORMED BY AN ADHESIVE

(75) Inventors: Arno Perner, Ellwangen (DE); Thomas Woehrle, Ellwangen (DE); Markus Kohlberger, Ellwangen (DE); Rainer Hald, Ellwangen (DE); Markus Pompetzki, Ellwangen (DE); Peter Haug, Ellwangen (DE); Calin Wurm, Ellwangen (DE); Dejan Ilic, Ellwangen (DE)

(73) Assignee: Varta Microbattery GmbH, a Corporation of Germany, Hannover (DE)

(21) Appl. No.: 12/518,658

(22) PCT Filed: Dec. 7, 2007
(86) PCT No.: PCT/EP2007/010679

§ 371 Date: May 9, 2011

(30) Foreign Application Priority Data
Dec. 20, 2006 (DE) 10 2006 062 407.6

(51) Int. Cl. H01M 4/583; H01M 2/02; H01M 2/16; H01M 4/62; H01M 4/52; H01M 4/38; B32B 37/00; H01M 10/02

(52) U.S. Cl. 429/163; 156/272.6; 156/299; 429/188; 429/217; 429/231.3; 429/231.8; 429/231.95; 429/246

(57) ABSTRACT

An electrochemical element includes at least one individual cell having electrodes arranged on a sheet-like separator, wherein the electrodes have been applied to the separator by at least one adhesive.

### RELATED APPLICATIONS

This is a §371 of International Application No. PCT/EP2007/010679, with an international filing date of Dec. 7, 2007 (WO 2008/080507 A1, published Jul. 10, 2008), which is based on German Patent Application No. 19 2996 062 407.6, filed Dec. 20, 2006.

### TECHNICAL FIELD

This disclosure relates to an electrochemical element comprising at least one individual cell having electrodes arranged on a sheet-like separator, a process for producing an electrochemical element comprising at least one individual cell having electrodes arranged on a sheet-like separator and also the use of an adhesive for producing an electrochemical element comprising at least one individual cell having electrodes arranged on a sheet-like separator.

### BACKGROUND

Lithium-polymer cells in many cases comprise a stack of cells which comprises a plurality of individual cells. The individual cells or single elements of which such a stack is composed are generally a composite of active electrode films, preferably metallic collectors arranged in each case between two electrode halves (generally aluminum collectors, in particular collectors made of aluminum expanded metal or perforated aluminum foil, for the positive electrode and copper collectors, in particular collectors made of solid copper foil, for the negative electrode) and one or more separators. Such individual cells are frequently produced as bicells having the possible sequences negative electrode/separator/positive electrode/separator/negative electrode or positive electrode/separator/negative electrode/separator/positive electrode.

The electrodes are generally produced by intensively mixing active materials, electrode binders such as the copolymer polyvinylidene fluoride-hexafluoropropylene (PVdF-HFP) and, if appropriate, additives such as conductivity improvers (generally carbon blacks or graphites) in an organic solvent such as acetone and applying the mixture to a suitable collector. The electrode foils provided with collectors which have been formed in this way are subsequently applied to preferably very thin, sheet-like separators, in particular film separators, and in this way processed to form the abovementioned individual cells, in particular the abovementioned bicells. Possible separators are, for example, thin films of polyethylene (PE), polypropylene (PP) or multilayer sequences of PE and PP.

The electrode foils are generally applied centrally to the separator, so that the separator has a free margin around the outside which is not covered by electrode material.

A plurality of individual cells or bicells can then be connected in parallel and stacked on top of one another to form the abovementioned stack of cells which is processed by introduction into a housing, for example a housing made of deep-drawn aluminum composite film, filling with electrolyte, sealing of the housing and final forming to give a finished battery.

Application of the electrode foils provided with collectors to the separators mentioned is generally carried out in a lamination step. The electrodes are pressed onto the separator under high pressure and at a high temperature, as is described, for example, in U.S. Pat. No. 6,579,643 or U.S. Pat. No. 6,337,101. Polyolefin separators are first provided on both sides with a bonding agent. This bonding agent comprises, for example, a PVdF-HFP (polyvinylidene fluoride-hexafluoropropylene) copolymer and a plasticizer, often dibutyl phthalate (DBP). The coated separator is laminated onto the electrodes with application of heat and pressure. U.S. Pat. No. 6,579,643 indicates temperatures of about 100° C. and pressures in the range from 20 to 30 pounds/inch as preferred lamination parameters.

However, increasing problems in carrying out such a lamination process have occurred in recent years, which can be attributed to the fact that ever thinner separators are being used to increase the energy density, in particular, in lithium-polymer cells. When a very thin separator is used, it is possible for the separator to be damaged or even perforated by particles present in the electrodes under the high pressures and high temperatures which occur during lamination. The resulting cells are, therefore, frequently at risk of at least latent short circuits.

In addition, shrinkage of the separator frequently occurs during lamination as a result of the high temperatures and this can likewise lead to short circuits at the margins of an individual cell.

It could, therefore, be helpful to provide electrochemical elements which are reliable in their absence of short circuits and, associated therewith, also in respect of their safety behavior.

### SUMMARY

We provide an electrochemical element including at least one individual cell having electrodes arranged on a sheet-like separator, wherein the electrodes have been applied to the separator by at least one adhesive.

We also provide a process for producing an electrochemical element including at least one individual cell having electrodes arranged on a sheet-like separator, wherein the electrodes are adhesively bonded to the separator.

### BRIEF DESCRIPTION OF THE DRAWINGS

FIG. 1 is a graph of remaining capacity as a function of cycling.

FIG. 2 is a graph of temperature as a function of time.

FIG. 3 is a graph of temperature as a function of time.

### DETAILED DESCRIPTION

Our electrochemical elements comprise at least one individual cell having electrodes arranged on a sheet-like separator. The electrodes are applied to the separator by means of at least one adhesive.

This at least one individual cell is in particular a bicell. This preferably has a sequence of negative electrode/separator/positive electrode/separator/negative electrode or of positive electrode/separator/negative electrode/separator/positive electrode.

An electrochemical element preferably has a layer of adhesive which is located between the separator and electrodes. The layer of adhesive preferably has electrically insulating properties, but is permeable to customary electrolytes. The layer of adhesive may completely cover the region between the electrodes and the separator so that the electrodes are adhesively bonded over their entire area to the separator. In this case, there are no longer any direct contact points between the electrodes and the separator.

The electrodes can also be adhesively bonded only in subregions to the separator. In subregions which are free of adhesive, the electrodes can then be in direct contact with the separator.

It is also possible for the separator and the electrodes to be adhesively bonded to one another at points. The adhesive need not be present over an entire area, but only in the form of one or more points between the electrodes and the separator.

An electrochemical element is, in particular, distinguished by being less at risk of short circuits than comparable conventional electrochemical elements and displays an equally good performance. The latter is surprising since interfering effects of a layer of adhesive on the separator could not have been ruled out a priori in a lithium-polymer cell.

The at least one adhesive is, in particular, one or more adhesives which can be employed at room temperature. Particular preference is given to adhesives which do not have to be activated by heat and/or can be cured at room temperature. The at least one adhesive is particularly preferably an adhesive which can be applied in liquid form, for example, by spraying. In liquid form, the adhesive can easily take on the surface contours of the electrodes and the separator. The at least one adhesive used is preferably chemically inert toward customary constituents of an electrochemical cell, e.g., organic electrolytes, in particular electrolytes composed of organic carbonates together with conductive lithium salts such as lithium hexafluorophosphate (LiPF₆) or lithium tetrafluoroborate (LiBF₄). The adhesive may be free of solvents, in particular, organic solvents.

The at least one adhesive preferably comprises at least one chemically curing adhesive. The solidification of the chemically curing adhesive occurs by chemical reaction of individual adhesive components to form chemical bonds. The at least one chemically curing adhesive can be a one-component or multi-component system, in particular, a two-component system. In the case of a multicomponent system, a plurality of components are mixed with one another in a defined ratio before application. A chemical reaction between the components generally commences even during mixing. The mixture is accordingly processable or applyable only within a particular time after mixing. In the case of a one-component system, a ready-to-use adhesive is applied and cures as a result of changes in the ambient conditions, for example, by access of atmospheric moisture or oxygen.

The at least one adhesive may comprise at least one physically setting adhesive. A physically setting adhesive is an adhesive which is solidified by formation of physical interactions between individual molecules of the adhesive. Such an adhesive is frequently applied in dissolved or dispersed form and cures as a result of evaporation of the solvent or of the dispersion medium. The interactions between the individual molecules of the adhesive are generally purely cohesive forces.

Well-suited adhesives are, in particular, organic adhesives, in particular, those based on polymers. The at least one adhesive particularly preferably comprises at least one adhesive based on acrylate, cyanoacrylate, methyl methacrylate, phenol-formaldehyde resin, epoxy resin, rubber, polyurethane, polyolefin waxes, polyolefins modified with polar groups, polysiloxane and/or silicone. The at least one adhesive is particularly preferably an acrylate and/or silicone adhesive.

The layer of adhesive preferably has a thickness in the range from about 0.1 μm to about 25 μm, preferably from about 3 μm to about 15 μm, in particular, about 5 μm. Basically, an attempt is made to keep the layer of adhesive as thin as possible.

Separators which can be used in an electrochemical element preferably consist essentially of at least one plastic, in particular, at least one olefin. The at least one olefin can be, for example, polyethylene. Particular preference is also given to using multilayer separators, for example, separators composed of a sequence of various polyolefin layers, in particular, the sequence polyethylene/polypropylene/polyethylene.

The separator can also comprise, in particular, polyether ether ketone (PEEK), polyphenyl sulfide (PPS) or polyester.

In particular, a separator can also comprise inorganic fillers such as titanium dioxide or silicon dioxide.

The separators which can preferably be used in an electrochemical element preferably have a thickness of from about 3 μm to about 50 μm, in particular, from about 10 μm to about 30 μm, particularly preferably from about 12 μm to about 18 μm. Preference is given to an electrochemical element comprising at least one individual cell having at least one lithium intercalating electrode. The electrochemical element is particularly preferably a lithium-polymer cell.

An electrochemical element preferably comprises at least one individual cell having at least one positive electrode comprising lithium cobalt oxide (LiCoO₂) as active material. Preference is also given to an electrochemical element comprising at least one individual cell having at least one negative electrode comprising graphite as active material.

Particular preference is given to an electrochemical element comprising at least one individual cell having at least one positive electrode based on lithium cobalt oxide and at least one negative electrode based on graphite, with the individual cell then preferably having a sequence of negative electrode/separator/positive electrode/separator/negative electrode or of positive electrode/separator/negative electrode/separator/positive electrode.

The electrodes of an electrochemical element preferably have collectors, in particular, collectors based on copper on the side of the negative electrode and collectors based on aluminum on the side of the positive electrode. The collectors are preferably provided with power outlet tabs which can be welded onto a power outlet lead which can be arranged to lead out of a housing of an electrochemical element.

The electrodes of an electrochemical element preferably have a thickness in the range from about 30 μm to about 200 μm, in particular, from about 70 μm to about 160 μm. The values indicated relate, in particular, to “finished” electrodes, i.e., electrodes which are provided with a collector.

If an electrochemical element has collectors, these are preferably used in a thickness in the range from about 5 μm to about 50 μm particular, from about 7 μm to about 40 μm. A thickness in the range from about 10 μm to about 40 μm is particularly preferred for collectors and power outlet tabs made of aluminum. In the case of collectors and power outlet tabs made of copper, a thickness in the range from about 6 μm to about 14 μm is particularly preferred.

Preference is given to the electrodes of an electrochemical element comprising a polymeric electrode binder, in particular, an electrode binder based on a PVDF-HFP copolymer.

The electrodes of an electrochemical element can also comprise polyvinylidene fluoride (PVdF), polyvinylidene fluoride-tetrafluoroethylene (PVdF-TFE), polytetrafluoroethylene (PTFE), polyethylene oxide (PEO), polyethylene glycol, cellulose and/or rubber as electrode binder.

An electrochemical element generally comprises an electrolyte, preferably an organic electrolyte containing at least one conductive lithium salt, in particular, a mixture of ethylene carbonate (EC) and diethyl carbonate (DEC) containing at least one conductive lithium salt such as lithium hexafluorophosphate (LiPF₆).

Furthermore, an electrochemical element may comprise a housing, preferably a housing made of a composite film, in particular, a composite film comprising at least one metal foil. The composite film is particularly preferably coated on the inside (i.e., on the side facing the electrodes) with an electrically insulating material such as polypropylene (PP) which, in particular, functions as sealing material.

It has surprisingly been found that our electrochemical elements not only have advantages over comparable conventional electrochemical elements in respect of their more reliable absence of short circuits, but it has been determined that the electrochemical elements also have lower formation losses on first charging and discharging than comparable conventional elements. In addition, they surprisingly also retain their voltage on prolonged storage better than do comparable conventional electrochemical elements. Without being bound by any particular theory, we believed that a reason for this is that in the case of conventional electrochemical elements the separator can easily be damaged during lamination, with places which are latently at risk of short circuits via which gradual discharge can take place can be formed. This is successfully avoided in our electrochemical elements by the adhesive bonding of the electrodes to the separator under mild conditions. Adhesive bonding at room temperature leads to damage to and shrinkage of the separator being largely avoided, in contrast to lamination under high pressure and at high temperatures.

We also provide processes for producing electrochemical elements. A process enables electrochemical elements comprising at least one individual cell having electrodes arranged on a sheet-like separator to be produced. In particular, the process makes it possible to produce electrochemical elements as have been described in detail above. The corresponding structures above will merely be referred to and incorporated by reference to avoid repetition.

Our process is distinguished by, in particular, the electrodes being adhesively bonded to the separator. The adhesives which can preferably be used in a process have been described in detail above. The corresponding aspects are hereby referred to and incorporated by reference.

Our process offers great advantages over conventional processes in which electrodes are laminated onto a separator. First, particular mention may be made of the processing of the separator under mild conditions which has been mentioned above. A separator cannot soften, melt or shrink in an adhesive bonding procedure. Second, an adhesive bonding step can easily be integrated into a production process and requires fewer complicated and expensive tools, process steps and machines than a lamination step.

In our process, at least one adhesive is preferably applied to a separator and, if appropriate, predried. In a subsequent step, an electrode is then applied to the separator provided with the adhesive.

The adhesive can be applied either to only one of the two surfaces to be adhesively bonded (electrode or separator) or to both surfaces. A two-component adhesive may be used and one of the components may be applied to one of the surfaces to be adhesively bonded and the other component may be applied to the other surface. When the two surfaces are brought into contact with one another, the adhesive is activated.

The separator is preferably subjected to a corona and/or plasma treatment before the electrodes are adhesively bonded on. This can improve the adhesion between the adhesive and the separator.

As an alternative or in addition, the separator can also be activated by means of a chemical primer before the electrodes are adhesively bonded on.

The electrodes and the separator may be pressed together during or after adhesive bonding. After pressing together, the composite of electrodes and separator can generally be immediately subjected to a mechanical load. Appropriate selection of pressing pressure enables the thickness of the layer of adhesive between the separator and the electrodes to be set in a targeted manner as a function of the amount of adhesive used.

The pressing-on of the electrodes is preferably carried out at relatively low temperatures, in particular at room temperature. The entire operation of adhesive bonding and pressing together is preferably carried out at room temperature. Depending on the type of adhesive selected, the curing of the adhesive can be accelerated by heating. However, this is a purely optional measure.

We also provide for the use of an adhesive for producing an electrochemical element comprising at least one individual cell having electrodes arranged on a sheet-like separator, in particular, for the adhesive bonding of electrodes and separator. The type and nature of electrodes and separators which are preferably adhesively bonded to one another have been defined above. The same applies to the type and nature of the adhesives which can be used. What has been said an the subjects is hereby referred to and incorporated by reference.

The abovementioned and further advantages of our electrochemical elements and methods can be derived from the following description of preferred aspects. The individual features can be realized either alone or in combination with one another. The representative examples described serve merely for the purpose of illustration and to give a better understanding and are not to be interpreted as constituting an restriction.

### Examples

### I. Production of an Example of an Electrochemical Element

### (1) Production of a Negative Electrode

200 ml of acetone are placed in a 500 ml plastic container. 24.75 g of a PVDF-HFP copolymer (Kynar Flex® 2801-00 from Arkema) having an HFP content of about 12% by weight are introduced and the solution is stirred by means of a laboratory stirrer (Eurostar IKA®) at room temperature. As soon as a clear solution has been formed, 7.1 g of carbon black are introduced as conductivity improver. After 10 minutes, 321.8 g of graphite MCMB 25-28 are introduced as active material in small portions; the mixture is subsequently stirred for another one hour at 1700 rpm.

The coated composition is subsequently applied as a film having a weight per unit area of about 15.4 mg/cm² to both sides of a collector made of 12 μm thick copper foil.

### (2) Production of a Positive Electrode

250 ml of acetone are placed in a 500 ml plastic container. 21.70 g of a PVDF-HFP copolymer (Kynar Flex® 2801-00 from Arkema) are dissolved therein. After a clear solution has been formed, 3.1 g of conductivity black and 3.1 g of graphite are introduced as conductivity improvers. After a short time, 276.2 g of lithium cobalt oxide as active material are added a little at a time while stirring vigorously.

The coating composition produced is applied by means of a doctor blade to a collector made of aluminum expanded metal (weight per unit area without collector: about 40 mg/cm²).

(3) Production of a Separator Coated with Acrylate Adhesive

A separator (three-layer film composed of polypropylene/polyethylene/polypropylene) having a thickness of 25 μm is firstly pretreated on the surface. For this purpose, this separator is chemically activated by means of DELO-PRE 2005. The membrane is sprayed with the activator and dried at room temperature for 5 minutes. The surface tension increases from 28 mN/m to 34 mN/m as a result. The separator is subsequently sprayed on both sides with a diluted aqueous acrylate adhesive dispersion (Acronal® 3432 from BASF) and dried by means of hot air (˜60° C.). The resulting layer of adhesive has a thickness of about 2 μm.

### (4) Production of Bicells

Bicells of an electrochemical element are manufactured from negative electrodes produced as described in (1), positive electrodes produced as described in (2) and the separator as per (3).

For this purpose, strips are in each case stamped from the negative electrodes from (1) and the positive electrodes from (2). A separator as described in (3) is firstly adhesively bonded to each of the two sides of a negative electrode. In a second step, the upper and lower positive electrodes are then each adhesively bonded centrally to the free sides of the separators. A margin around the outside of the separators remains free of electrode material.

### (5) Manufacture of a Stack of Cells and Installation of the Stack in a Housing

Six bicells produced as described in (4) are placed on top of one another to form a stack of cells and connected in parallel by welding together of the power outlet leads. This stack is placed in a housing of deep-drawn aluminum composite film. This is followed by filling with electrolyte, sealing of the housing and final formation.

The electrochemical element produced has a length of 41 mm, a width of 34 mm and a height of 2.6 mm.

### II. Production of a Conventional Electrochemical Element Comprises Individual Cells Made Up of Electrodes and Separators which have been Connected to One Another in a Conventional Manner by Lamination

An electrochemical element was produced in a manner analogous to I., with step (3) being omitted and the electrodes not being adhesively bonded to the separator but instead being laminated on at high temperatures and pressures in step (4), unlike the above-described procedure.

### III. Formation Tests were Carried Out on an Electrochemical Element Produced as Described in I. and an Electrochemical Element Produced as Described in II

The electrochemical element was in each case charged with a particular amount of energy and subsequently discharged completely. The amounts of energy transferred during charging and discharge were measured in each case.

A higher formation loss was surprisingly measured in the case of conventional electrochemical elements (produced as described in II.) than in the case of our electrochemical elements. In the case of conventional electrochemical elements, the formation loss is about 10%, while our cells display reduced formation losses of about 8%.

The results of the respective measurements are summarized in Table 1:

TABLE 1
Formation losses

| | First | First | Formation |
|---|---|---|---|
| | charging | discharge | loss |
| Structure | [Ah] | [Ah] | [%] |
| Electrochemical element as per II. | 0.337 | 0.304 | 10 |
| Electrochemical element as per I. | 0.332 | 0.305 | 8 |

The larger formation losses in the case of electrochemical elements produced as described in II. are presumably attributable to the fact that the separator used was easily damaged at individual points in the lamination step during production. Electric potential can break through at the damaged points during formation, which explains the higher formation losses.

### IV. Electrochemical Elements Produced as Described in I. and as Described in II. were Charged to about 50% of their Capacity

The elements were stored at room temperature. The voltage of the electrochemical elements was in each case measured at regular intervals over a period of several months.

A significant voltage drop was determined in the case of conventional electrochemical elements (cells produced as described in II.), in contrast to electrochemical elements according to the invention (see Table 2).

TABLE 2
Results of the voltage measurements

| | Voltage at | Voltage | Voltage | Voltage |
|---|---|---|---|---|
| | commencement | after 14 | after 1 | after 3 |
| Structure | of storage [V] | days [V] | month [V] | months [V] |
| Electrochemical | 3.890 | 3.850 | 3.840 | 3.830 |
| element as per II. | | | | |
| Electrochemical | 3.890 | 3.890 | 3.890 | 3.888 |
| element as per I. | | | | |

The reason for this is assumed to be, as mentioned above, that gradual discharge takes place via the damaged points of the separator in electrochemical elements having the conventional structure as per II.

### V. The Same Tests as in IV. were Carried Out on Virtually Discharged Electrochemical Elements at a Correspondingly Lower Voltage

The results (summarized in Table 3) were comparable. No voltage drop at all was observed in the case of electrochemical elements.

TABLE 3
Results of the voltage measurements

| | Voltage at | | | | Differ- |
|---|---|---|---|---|---|
| | commence- | Voltage | Voltage | Voltage | ential |
| | ment of | after | after | after | voltage |
| Structure | monitoring [V] | 1 h [V] | 2 h [V] | 5 h [V] | [V] |
| Electrochemical | 2.890 | 2.890 | 2.888 | 2.887 | 3.0 |
| element as per II. | | | | | |
| Electrochemical | 2.890 | 2.890 | 2.890 | 2.890 | 0.0 |
| element as per I. | | | | | |

### VI. Long-Term Cycling at 1 C was Carried Out at Room Temperature on an Electrochemical Element Produced as Described in I. and an Electrochemical Element Produced as Described in II

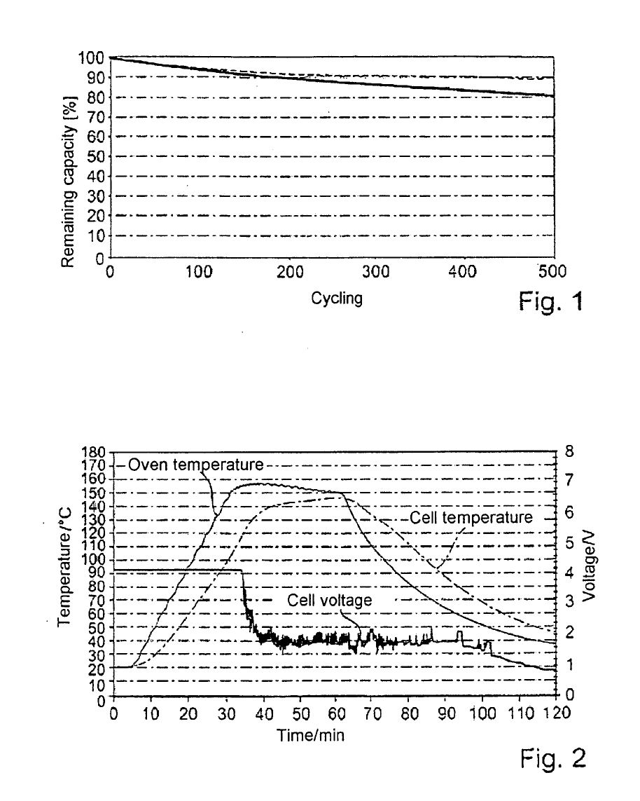

The results are shown in FIG. 1 (the upper curve was measured for the element produced as described in I., and the lower curve for the element produced as described in II.). An improved long-term behavior was observed for the electrochemical elements compared to the conventional elements.

### VII. An Oven Test at a Cell Voltage of 4.2 V was Carried Out on an Electrochemical Element Produced as Described in I

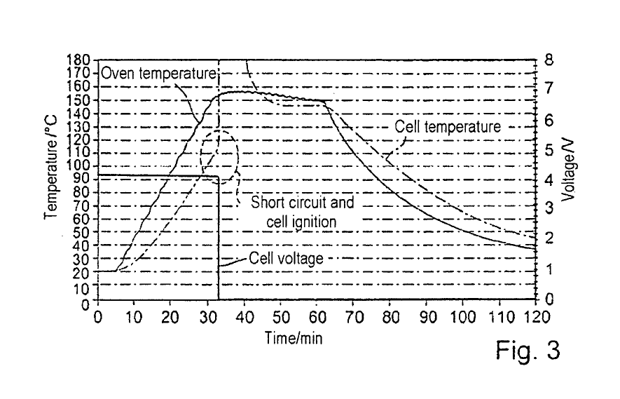

The electrochemical element was subjected to a temperature of 150° C. for 30 minutes. The test is considered to be passed if an electrochemical element does not ignite or explode. The results of the test are shown in FIG. 2. The electrochemical element passed the oven test without problems. In contrast, problems occurred in the same test in the case of conventional electrochemical elements produced as described in II. (shown in FIG. 3). This demonstrates the safety advantage of electrochemical elements produced by cold adhesive bonding.

1-24. (canceled)

25. An electrochemical element comprising at least one individual cell having electrodes arranged on a sheet-like separator, wherein the electrodes have been applied to the separator by at least one adhesive.

26. The electrochemical element as claimed in claim 25, wherein the electrodes have been applied to the separator by at least one adhesive which can be cured at room temperature.

27. The electrochemical element as claimed in claim 25, wherein a layer of adhesive is present between the separator and the electrodes.

28. The electrochemical element as claimed in claim 25, wherein the electrodes are adhesively bonded over their entire area or only in subregions to the separator.

29. The electrochemical element as claimed in claim 25, wherein the separator and the electrodes are adhesively bonded to one another at points.

30. The electrochemical element as claimed in claim 25, wherein the at least one adhesive comprises at least one chemically curing adhesive.

31. The electrochemical element as claimed in claim 25, wherein the at least one adhesive comprises at least one physically setting adhesive.

32. The electrochemical element as claimed in claim 25, wherein the at least one adhesive comprises at least one organic adhesive.

33. The electrochemical element as claimed in claim 25, wherein the at least one adhesive comprises at least one adhesive selected from the group consisting of adhesives based on acrylate, cyanoacrylate, methyl methacrylate, phenolformaldehyde resin, epoxy resin, rubber, polyurethane, polyolefin waxes, polyolefins modified with polar groups, polysiloxane and silicone.

34. The electrochemical element as claimed in claim 25, wherein the layer of adhesive has a thickness in the range from about 0.1 μm to about 25 μm.

35. The electrochemical element as claimed in claim 25, wherein the separator is a plastic separator.

36. The electrochemical element as claimed in claim 25, wherein the separator is a separator based on at least one polyolefin.

37. The electrochemical element as claimed in claim 25, wherein the separator has a thickness in the range from about 3 μm to about 50 μm.

38. The electrochemical element as claimed in claim 25, wherein at least one of the electrodes is a lithium-intercalating electrode.

39. The electrochemical element as claimed in claim 25, wherein a positive electrode based on LiCoO₂ has been applied to the separator.

40. The electrochemical element as claimed in claim 25, wherein a negative electrode based on graphite has been applied to the separator.

41. The electrochemical element as claimed in claim 25, wherein the electrodes comprise a polymeric electrode binder comprising a PVDF-HFP copolymer.

42. The electrochemical element as claimed in claim 25, wherein the electrodes comprise an electrode binder based on a PVDF-HFP copolymer.

43. The electrochemical element as claimed in claim 25, wherein the electrodes have a thickness in the range from about 30 μm to about 200 μm.

44. The electrochemical element as claimed in claim 25, further comprising an organic electrolyte.

45. The electrochemical element as claimed in claim 25, comprising an electrolyte based on a mixture of ethylene carbonate and diethyl carbonate with at least one conductive lithium salt.

46. The electrochemical element as claimed in claim 25, further comprising a housing made of composite film.

47. The electrochemical element as claimed in claim 25, further comprising a housing made of a composite film having a layer of metal.

48. A process for producing an electrochemical element comprising at least one individual cell having electrodes arranged on a sheet-like separator, wherein the electrodes are adhesively bonded to the separator.

49. The process as claimed in claim 48, wherein the separator is subjected to a corona and/or plasma treatment before the electrodes are adhesively bonded on.

50. The process as claimed in claim 48, wherein the separator is activated by a chemical primer before the electrodes are adhesively bonded on.

51. The process as claimed in claim 48, wherein the electrodes and the separator are pressed together during or after adhesive bonding.

52. The process as claimed in claim 51, wherein pressing together of the electrodes is carried out at room temperature.
